(19) United States
(12) Patent Application Publication
(10) Pub. No.: US 2010/0066990 A1
(43) Pub. Date: Mar. 18, 2010

(54) IMAGING DEVICE WITH EXCHANGEABLE DIAPHRAGMS AND METHOD THEREFOR

(75) Inventors: Hermann Bieg, Huettlingen (DE); Yim-Bun Patrick Kwan, Aalen (DE); Uy-Liem Nguyen, Daettwil (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/549,541

(22) Filed: Aug. 28, 2009

Related U.S. Application Data
(63) Continuation of application No. PCT/EP2008/052210, filed on Feb. 22, 2008.

(30) Foreign Application Priority Data
Feb. 28, 2007 (DE) 102007009867.9

(51) Int. Cl. G03B 27/72; G03B 27/32

(52) U.S. Cl. 355/71; 355/77

(57) ABSTRACT

The disclosure concerns a method for exchangeable introduction and/or exchange of diaphragms in an imaging device, such as an EUV projection exposure system for microlithography or a corresponding imaging device with a housing and at least one diaphragm, which is accommodated exchangeably in the housing and at least one transfer device with at least one receptacle, on or at which the diaphragm can be detachably arranged in order that it may be moved in or out of the objective space. At least one receptacle of the transfer device, on or at which the diaphragm can be detachably arranged, is an element of the diaphragm mount for positioning the diaphragm in the housing.

### CROSS-REFERENCE TO RELATED APPLICATIONS

This application is a continuation of, and claims benefit under 35 USC 120 to, international application PCT/EP2008/052210, filed Feb. 22, 2008, which claims benefit of German Application No. 10 2007 009 867.9, filed Aug. 28, 2007. International application PCT/EP2008/052210 is hereby incorporated by reference in its entirety.

### FIELD

The disclosure relates to an imaging device, such as an EUV (extreme ultraviolet) projection exposure system for microlithography, having at least one housing and at least one diaphragm that is accommodated exchangeably in the housing and at least one transfer device with at least one receptacle, on or at which the diaphragm can be detachably arranged so that it may be moved in or out of an objective space. The disclosure also relates to a method of operating such an imaging device or for exchangeable introduction and/or replacement of diaphragms in the imaging device.

### BACKGROUND

Diaphragm-changing devices for an EUVL objective for microlithography are known. The diaphragm-changing devices may allow for a selected diaphragm to be introduced into the objective from a diaphragm store via a feeder device. The feeder device can have a single or double gripper, which can accordingly accommodate and move one or two diaphragms simultaneously.

### SUMMARY

In some embodiments, the disclosure provides a diaphragm-changing device for an imaging device or a correspondingly equipped imaging device for microlithography, such as an imaging device for the use of extreme ultraviolet light, that makes possible fast and effective diaphragm changing with a plurality of diaphragms combined with the maximum possible flexibility of the diaphragms to be used. In addition, the device is to be designed such that, through the device and its operation, the fewest possible impurities are introduced into the housing of the imaging device, a fact which can be especially important for vacuum-operated EUV projection exposure systems. In addition, a corresponding method for replacing and changing diaphragms is to be specified. Both the device and its operation or the corresponding method are to be easy to implement, and the device is to be easy to produce in particular.

The disclosure is based, in part at least, on the realization that clear efficiency gains can be made by integrating the holding and/or positioning functions within the housing of an imaging device into the feeder device or transfer device because on one hand an additional holding and lifting device of the kind described in WO2005/050 322 A1 can be eliminated and, on the other, transfer operations from the feeder device or transfer device to the holding and lifting device can be saved. Furthermore, the transport processes can be greatly reduced in such an embodiment and also in the case of a transfer device equipped as a single gripper or with a single receptacle for a diaphragm. Thus, even in the case of a transfer device with a single diaphragm receptacle, only two transport operations may be involved to replace the diaphragm. Since at least the receptacle of the transfer device remains in the housing of the imaging device during operation, a change of diaphragm initially involves only the diaphragm hitherto in use be traversed out of the housing and, after the diaphragm has been replaced outside the housing at the corresponding diaphragm store, the new diaphragm is traversed into the housing again. Empty transports can thus eliminated.

As used herein, “imaging device” is understood to mean both the illumination system and the projection objective of a projection exposure system. Moreover, the imaging device can refer to only part of an illumination system or a projection objective in the form of an assembly of optical elements.

As used herein, the term “objective” is not restricted to a certain type of imaging device, but rather is synonymous with any kind of an assembly of optical elements.

As used herein, the terms “objective space” and “housing of an imaging device” are used synonymously, with objective space meaning the enclosed space in which a group of optical elements is arranged and the housing partly or completely encloses a corresponding space.

Transfer device is understood herein to mean any transport or movement device that enables a detachably arranged diaphragm to be moved into and out of the objective space of an objective or a housing of an imaging device. Receptacle is understood herein to mean any device or equipment that permits detachable accommodation or holding of a diaphragm. The diaphragm can be formed as a one-piece or multi-piece diaphragm and particularly as a diaphragm unit, for example, with a mount or similar. In addition, various diaphragms, such as hole diaphragms, ring diaphragms can be used.

In some embodiments, the diaphragm-changing device is configured so that the holding and/or positioning function of the diaphragm in the imaging device is integrated into the transfer device for transporting the diaphragm into and out of the imaging device. Accordingly, in certain embodiments, the transfer device is formed so as to be so rigid that exact positioning of the diaphragm in the imaging device is possible. Certain known transfer devices have low rigidity, dimensioned solely so as to satisfy transport purposes. The disclosure provides embodiments in which a transfer device has adequate rigidity for holding and positioning the diaphragm in the imaging device. This rigidity is obtained when the transfer device and/or at least the receptacle has an eigenfrequency that is greater than or equal to 100 Hz, such as greater than or equal to 300 Hz.

In some embodiments, the imaging devices facilitate diaphragm-changing time is less than or equal to 15 seconds (e.g., less than or equal to 10 seconds, less than or equal to 5 seconds). Accordingly, especially for projection exposure systems, rapid diaphragm changes and hence a rapid setup change overall is possible both in the illumination system and the projection objective.

The transfer device can have not just one receptacle, but several receptacles, especially two receptacles, for the purpose of thereby eliminating further transport operations and further shortening the diaphragm-changing times. For example, the transfer device may be formed with two or more receptacles such that one receptacle with the currently used diaphragm is arranged in the housing, while the other receptacle(s) are outside the housing, such that a change of diaphragms or an arrangement of the diaphragms in the receptacle can be made.

However, it is also possible for the imaging device and the diaphragm-changing device to be formed such that two or more receptacles are provided in the housing, with one receptacle with the currently used diaphragm located in the beam path, while the second or other receptacle is outside the beam path with another, possibly frequently used diaphragm in a position waiting to be introduced into the beam path by a brief movement.

The transfer device can effect transport of the diaphragms into and out of the housing by all kinds of movements. For example, the transfer device and/or the receptacles assigned to it can execute rotary or swivelling movements and/or linear-translation movements. A combination of different types of movement, such as a combination of a linear movement with a rotary or swivelling movement, affords particularly great flexibility.

The transfer device and/or the receptacles assigned to it can execute any movement in space, especially linear movement along the orthogonal space axes or in a plane and a direction perpendicular to it. For example, the movement in an x-y plane can be used for the purpose of traversing into and out of the imaging device while a movement perpendicular to that in the z-direction can serve the purpose of precision positioning and/or immobilization of the diaphragm in the imaging device.

The one or plurality of receptacles can be permanently or detachably connected to the rest of the transfer device. In a detachable arrangement, for example, a coupling point with the rest of the transfer device can be provided such that the receptacle with the diaphragm arranged thereon can be isolated from the rest of the transfer device in the area of the housing, such that no vibrations or shocks can be transferred from the rest of the transfer device to the imaging device while the imaging device is in use. For example, in the case of a guide rail, an actuation element can be provided for the receptacle, the element capable of being coupled to the receptacle and of traversing in the rail. After positioning of the receptacle with the diaphragm, the actuation element can be decoupled from the receptacle but remain in the housing. The provision of the coupling point outside or on the housing can also prevent coupling processes from generating particles in the interior of the imaging device.

Via a permanent connection between the receptacle and the transfer device, time-consuming coupling and uncoupling processes can be eliminated.

The transfer device can include any suitable mechanism by which movement of the diaphragm into and out of the housing of the imaging device can be effected. Such actuation mechanisms or drives can include parallelogram guides, telescopic guides, rail guides, roller guides and/or magnetic holders, whose attainable rigidity (e.g. parallelogram guide) or favourable ease of being influenced for compensating positioning errors (e.g. magnetic holders) render them particularly favourable for use in the transfer device.

In some embodiments, it is possible to use one and the same transfer device to move several receptacles which are capable of coupling with the rest of the transfer device, such that possibly time-consuming diaphragm-changing operations on or at the receptacles can be eliminated or these can be performed separately and/or at a remove from the imaging device.

The imaging device can have one or more stop elements, especially acting in different spatial directions, for interaction with the receptacle(s) or the transfer device, such that, through corresponding approach towards the stops or jamming of the receptacles and/or transfer device against the stops, precise, defined positioning and/or immobilization of the diaphragms in the imaging device is possible. The stops may be formed in all kinds of ways, often to avoid of kinematic over-determination, i.e. determination beyond the degrees of freedom of movement. This ensures that forces on the diaphragms that may stem from kinematically overdetermined mounting do not give rise to faulty positioning and/or deformation of the diaphragms.

Instead of the stop elements in the housing, stop elements or arresting devices may be provided for the transfer device, particularly if the receptacle is rigidly connected to the rest of the transfer device.

By virtue of the rigid configuration of the transfer device and/or the provision of corresponding stop elements, the diaphragm can be arranged with an accuracy such that the deviation from the set position, i.e. for example the distance of the centre or other reference point of a diaphragm from the intended position is less than or equal to 1 mm (e.g., less than or equal to 500 μm, less than or equal to 250 μm, less than or equal to 100 μm). Correspondingly, in a projection exposure system for microlithography, the illumination system and/or the projection objective is designed such that a deviation of a diaphragm in the range of less than or equal to 1 mm (e.g., less than or equal to 500 μm, less than or equal to 100 μm) from the set position can be compensated or is tolerated.

The tolerance can be achieved by already setting the design of the projection exposure system or of the components such that the beam path automatically tolerates deviations of such a slight nature. Additionally, it is possible to provide active compensation, whereby corresponding sensor devices and control units can be provided which register the deviations and/or the resultant imaging errors and compensate via corresponding actuators which are actuated by the control units.

Additionally or alternatively, it is possible to effect not only optical compensation, for example by movement or tensioning of optical elements, but to directly counteract the deviation of the diaphragm position by registering the deviation of the diaphragm position or a movement of the diaphragm and compensating by an actuator which is controlled by a control unit. Via a real-time control, corresponding vibrations of the diaphragm or the transfer device can be compensated in this way.

In addition to a single transfer device, several transfer devices (e.g., two transfer devices), optionally in a mirror-image alignment with the housing, may be provided. This allows, for example, the receptacle of the one transfer device to be loaded and unloaded, while the receptacle of the other transfer device is arranged in the housing with the diaphragm currently in use. The provision of two transfer devices means that vibrations or shocks caused by the loading and unloading of one transfer device are not transferred to the other transfer device, which is provided separately or that decoupling is simpler and more feasible.

The diaphragm-changing device or a corresponding imaging device can provide at least one, two or more stores for provisioning a large number of diaphragms, with the diaphragms or diaphragm arrangements capable of being stored singly in the store(s) or, in the event of detachable receptacles, already on a plurality of receptacles.

Optionally, the receptacles of the transfer device can be formed such that they can receive the diaphragms directly from the store and/or deposit them there.

This can be made possible, for example, by forming the stores so as to be movable, especially linearly movable in the various, especially orthogonal spatial directions. As a result, the stores can be arranged, for example, above the receptacles such that lowering the stores causes the diaphragms in the compartments to rest on the receptacles, where, for example, they are deposited in the exact position by corresponding centring devices and the like.

Alternatively or additionally, separate transfer devices, such as robotic arms and the like, may be provided to position the diaphragms from the stores on or at the receptacles of the transfer device, and vice versa.

Since the diaphragm-changing device can be used for EUV projection exposure systems, the components arranged outside the housing, such as transfer device and/or stores and/or transfer devices and the like can be arranged in a vacuum chamber at the housing, such that the vacuum prevailing in the housing is not impaired by a changing operation.

Furthermore, closure elements, and/or lock devices may be provided at the imaging device or the housing that close or isolate the desired opening for the purpose of introducing and removing the diaphragms into and from the housing. As a result, the atmosphere in the housing can be largely maintained and additionally these devices offer protection against ingress of contaminants such as particles and the like.

An imaging device or a diaphragm-changing device correspondingly provided there can now be operated such that, in a first step, a diaphragm is attached to or at the receptacle of a transfer device, this diaphragm being moved in a second step into the housing of the imaging device by the transfer device and in a third step the receptacle with the diaphragm being immobilized in the housing. In this state, the imaging device can be operated with the diaphragm provided there. For a corresponding change of diaphragms or removal of the diaphragm used previously, the immobilization of the diaphragm is released in a fourth step, for example, by loosening the clamp for the stop elements, the diaphragm is then removed from the housing in a fifth step by the transfer device, which can also be used to release the immobilization, and the diaphragm can be removed again from the receptacle in a sixth step. The receptacle is thus immediately ready for the arrangement of a new diaphragm, such that the corresponding procedural steps can be repeated.

Insofar as the transfer device for the implementation of the method has several receptacles, especially two receptacles, various steps of the method can be performed simultaneously at both receptacles. Thus, for example, the introduction of one diaphragm can be effected at the same time as the other diaphragm is removed. This can be realized, for example, by a rotating transfer device in the form of a carousel, in which, when one diaphragm is rotated out of the imaging device, the other diaphragm in a second receptacle is automatically rotated into the imaging device.

Furthermore, the immobilization or release of the immobilization of a first receptacle in the housing, can, given a second receptacle outside the housing, be simultaneously accompanied by loading and/or unloading of the receptacle. This is particularly advantageous because, during the corresponding immobilization steps, shocks or vibrations due to loading or unloading of the second receptacle are noncritical compared to corresponding vibrations or shocks during operation of the imaging device.

### BRIEF DESCRIPTION OF THE DRAWINGS

Further advantages, characteristics and features are apparent from the following detailed description of embodiments using the enclosed drawings. The drawings show in purely schematic form.

FIG. 1 is a side view of a part of an objective;

FIG. 2 is a plan view of an objective;

FIG. 3 is a plan view of an objective;

FIG. 4 is a plan view of an objective;

FIG. 5 is a plan view of an objective;

FIG. 6 is a plan view of a section of the transfer device of FIG. 1;

FIG. 7 is a representation of a projection exposure system;

FIGS. 8a and 8b are plan views of an imaging device including a transfer device which contains a parallelogram guide;

FIG. 9 is a side view of a transfer device including a telescopic guide;

FIGS. 10a and 10b are side and cross-sectional views, respectively, of a transfer device including a roller guide; and

FIGS. 11a and 11b are side and cross-sectional views, respectively of a transfer device including a magnetic bearing.

### DETAILED DESCRIPTION

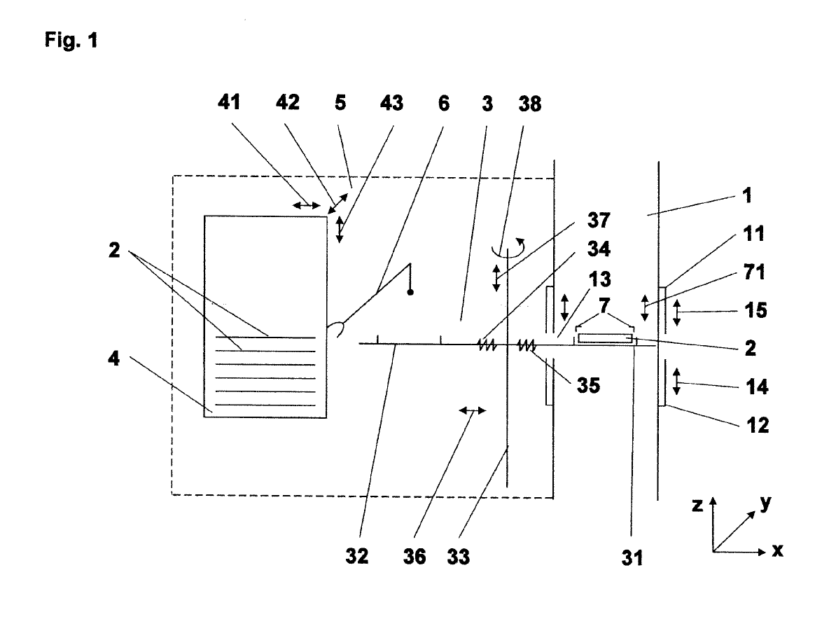

FIG. 1 is a purely schematic illustration of part of an objective space 1 of an objective with an exchangeable diaphragm 2. The objective space 1 is enclosed by walls not described in further detail, for example, a cylindrical-tubular sleeve, which has a slit-like opening 13, through which a diaphragm 2 can be introduced into and removed from the objective space 1. The diaphragm 2 is mounted in a receptacle 31 of a revolving carousel 3, the receptacle serving as a transfer device for introducing and removing the diaphragm 2 into the objective space 1 and out again.

Provided in the objective space 1 are stops 7, which can immobilize the diaphragm 2 in the objective space 1. To this end, the stops 7, as shown by the double-headed arrows 71, are movable, such that by a movement along the optical axis (corresponding to the z axis) of the objective, they can be traversed so as to stop against diaphragm 2. This allows the diaphragm 2 to be clearly immobilized in position.

Alternatively, it is also possible to move the diaphragm 2 in the direction of permanent stops 7, for example, by a corresponding movement of the carousel 3 in the z-direction, which is indicated by the double-headed arrow 37.

It is also conceivable that the diaphragm 2 be allowed to rest, under gravity alone, on the receptacle 31 and the centring devices (not shown) there provided of the carousel 3, and therefore not to provide an additional immobilization device in the z-direction.

Moreover, stops, not shown, can be provided for positioning or immobilization in the x and y directions, the stops interacting directly with the diaphragm 2 and/or the carousel 3. Such stops or immobilization devices can also be realized by the drive of the carousel 3, for example, by corresponding brakes. An important aspect is that the diaphragm 2 is immobilized on the receptacle 31 of the carousel 3 in the objective space 1 and the receptacle 31 of the carousel 3 remains in the objective space 1 for as long as the diaphragm 2 is being used in the objective.

The carousel 3 has a vertical rotary axis 33, which facilitates swivelling or rotation of the receptacle 31 in accordance with the arrow 38.

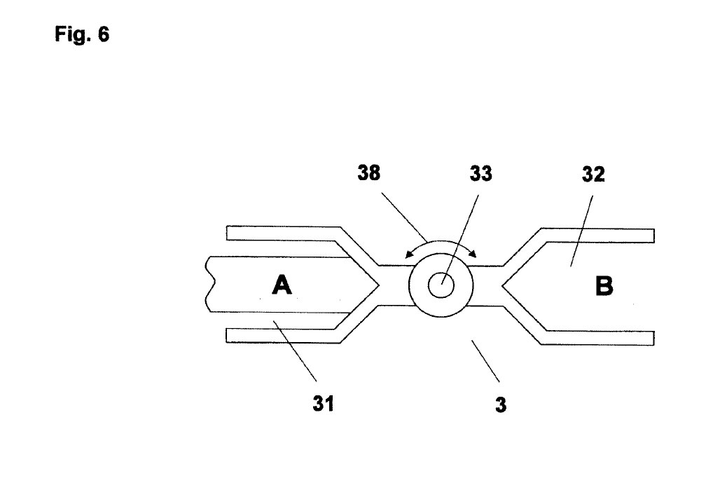

As regards the rotary axis 33, the receptacle 31 is opposite a second receptacle 32, which may also be seen in FIG. 6, which shows a plan view of the carousel 3.

A further diaphragm can be arranged in the receptacle 32. Through swivelling or rotation of the carousel 3 about rotary axis 33 in accordance with the arrow 38, receptacle 32 can be swivelled out at the same time as receptacle 31 is swivelled into the objective space 1, and vice versa. Accordingly, one of the two receptacles 31 is arranged outside the objective space 1 insofar as the other objective is located in the receptacle space 1. This makes it possible for that receptacle which is arranged outside the objective space 1 to be loaded with a second diaphragm or for this to be removed, i.e. replaced, during usage of the objective with a first diaphragm in the first receptacle.

To avoid shocks to the objective in this case, the receptacles 31 and 32 on the carousel 3 are connected to the rotary axis 33 via vibration dampers 34 and 35. By virtue of the vibration dampers 34 and 35, vibrations which arise from loading the receptacle 32 with a diaphragm 2 are not transmitted to the opposing receptacle 31, which is located in the objective interior.

Instead of the vibration dampers 34, 35, coupling elements (not shown) could also be provided to isolate the receptacles 31, 32 from the rest of the carousel 3.

The loading of the receptacles 31 or 32 can proceed via a separate transfer device 6, which, for example, may be formed as a gripper or robotic arm with corresponding gripper tools. The transfer device 6 can grip diaphragms 2 stored in a store 4, remove them from it and deposit them in or on the receptacle 32 or 31, and vice versa.

Alternatively, it is also possible to dispense with a separate transfer device 6, and either to design the carousel 3 so as to be traversable in accordance with the double-headed arrow 36 or to provide a movable store 4. In accordance with the double-headed arrows 41, 42 and 43, the store 4 can be pushed in each of the orthogonal spatial directions x, y and z, such that, for example, it is traversed in the direction of the carousel 3 in such a way that the receptacle 32 comes to lie beneath a diaphragm 2. Through corresponding lowering of the store or lifting of the carousel 3 in accordance with the double-headed arrow 37, the corresponding diaphragm 2 can be transferred to the receptacle 32 by simple placement on it.

It is also conceivable to arrange the store 4 near the carousel 3 such that, through the swivelling or rotary movement of the carousel 3 about the axis 33, the receptacle comes to lie beneath a diaphragm 2 directly in the store.

As such exchangeable diaphragms are provided especially for objectives that are operated with EUV light (extreme ultraviolet light), a vacuum or near-vacuum is present in objective space 1. Accordingly, adjacent to the objective space 1 is provided a vacuum chamber 5, which receives the store 4 and the transfer device in the form of the carousel 3, as well as the transfer device 6. This prevents a change of diaphragm from destroying the vacuum conditions in the objective space 1 when the replacement gap 13 is opened. To prevent contamination from gaining access to the interior of objective space 1, the gap 13 for replacing the diaphragms 2 can be provided with a closure device, which includes two sliding sleeves 11 and 12, which are formed so as to slide along the axis of the objective in accordance with the double-headed arrows 15 and 14. Accordingly, the slit 13 for replacing the diaphragms can be isolated at any vertical position of the receptacle 31 by the closure elements 11 and 12.

The mechanism by which the objective in accordance with FIG. 1 functions is such that, depending on the desired imaging conditions of the objective 1, a corresponding diaphragm 2 from the store 4 can be introduced into the beam path of the objective or into the objective space 1.

To this end, a diaphragm 2 is transferred from the store 4 to the carousel 3 (transfer device) by the transfer device 6 or through direct transfer from the store 4 to the transfer device 3, with the diaphragm 2, for example, coming to lie on the receptacle 32.

If the diaphragm 2, which has been arranged on or at the receptacle 32, is now introduced into the objective and thus into the objective space 1, the carousel 3 is rotated about rotary axis 33, while, at the same time, the diaphragm 2 in receptacle 31, which was previously arranged in the objective, is removed from the objective.

Insofar as the diaphragm 2 in the receptacle 31 was pressed against the stops 7, the immobilization of the diaphragm 2 is desirably released before the rotary movement of the carousel 3, by traversing either the stops 7 in accordance with the double-headed arrows 71 or the carousel 3 in the z-direction in accordance with the double-headed arrow 37.

In some embodiments, the operation for releasing the immobilization can be simultaneously accompanied by loading of the opposing receptacle 32, without vibrations leading to any impairment of the imaging quality of the objective.

As soon as the rotary movement of the carousel 3 about the rotary axis 33 is complete, the new diaphragm 2 is arranged on the receptacle 32 in objective space 1, while the previously used diaphragm 2 is arranged outside the objective space.

Now, the newly introduced diaphragm 2 can again be immobilized by traversing against the stops 7 in the objective space 1. Simultaneously, removal or exchange of the diaphragm on the opposing receptacle can occur.

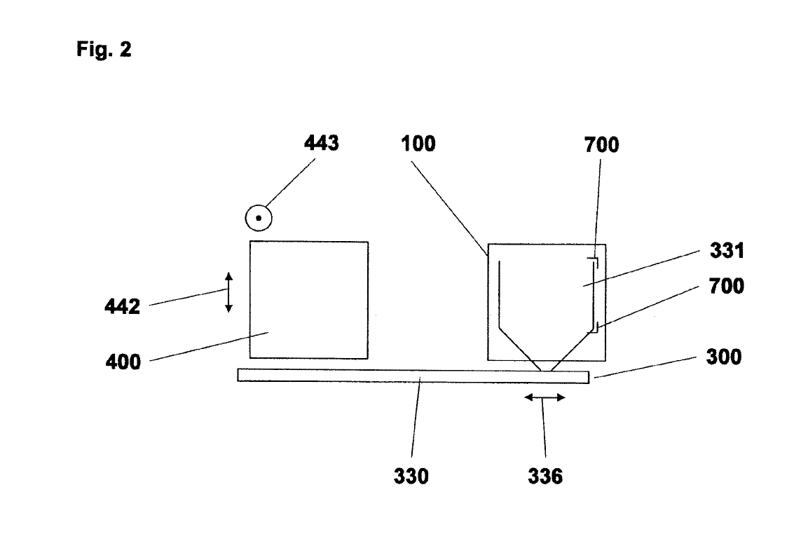

FIG. 2 shows of an objective with exchangeable diaphragms, with FIG. 2 showing a plan view in which, instead of a rotating carousel, a transfer device 300 is realized in the form of a linearly movable sliding arrangement.

The transfer device 300 of FIG. 2 has a linear movement unit 330 in the form of a rail arrangement with a chain drive or a contactless linear motor along which a receptacle 331 of the sliding arrangement can move back and forth, as shown by the arrow 336.

The receptacle 331 can move between an objective space 100 and a store 400, in which a plurality of diaphragms are stacked or stored.

The store 400 can move transversely in accordance with the arrow arrangements 442 and 443, especially perpendicularly, to the rail arrangement 330 and/or perpendicularly to the image plane, such that the diaphragms accommodated in the store 400 can be deposited in the receptacle 331 of the transfer device 300 by corresponding movements.

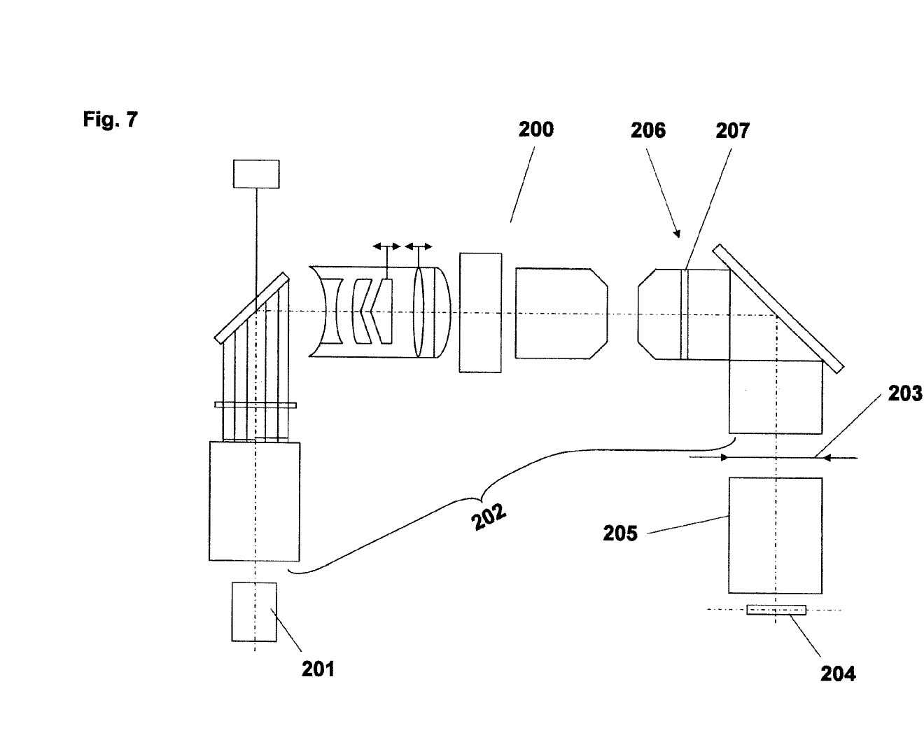

In the objective space 100 in turn are provided stops 700, which facilitate exact positioning of the receptacle 331 and/or the diaphragms arranged thereon. The stops 700 can, like the stops 7 in FIG. 1, can be installed so as to be capable of traversing or stationary. The stops 700 of FIG. 2 or 7 of FIG. 1 can be designed such that an exact positioning is possible without kinematic over-determination. This means that the diaphragm or the receptacle is exactly positioned and no longer has any degrees of freedom, but that mispositioning and/or deformation by the action of force is avoided through the avoidance of over-determination.

The mechanism by which FIG. 2 functions is as follows: First, the receptacle 331 is arranged via the transfer device 300 on the left side of the rail arrangement 330 in the area of the store 400 such that, through corresponding traversing and lowering of the store 400, a diaphragm 2 comes to lie in the receptacle 331. Then, the receptacle 331 is traversed along the rail arrangement 330 of the transfer device 300 into the objective space 100 by a linear-translation movement until the receptacle 331 and/or the diaphragm 2 arranged thereon make contact with the stops 700, which define their exact position. As a result, the diaphragm is immobilized for operation of the objective. Upon completion of objective operation with the chosen diaphragm, the latter is traversed out of the objective space 100 and the diaphragm is exchanged in the area of the store 400 in such a way that first the previously-used diaphragm is deposited and a new diaphragm is accommodated in the receptacle 331. Then, receptacle 331 traverses into the objective space 100 again.

The arrangement of the diaphragm in the objective on the receptacle 331 can save an inward and outward traversing movement of receptacle 331 and the corresponding transfer or holding device in the objective. In some known systems, the diaphragm in the objective would have first been transferred to the inwardly traversed transfer device or receptacle, after which the last-used diaphragm would have been traversed outwardly with the transfer device. This alone would have generated two inward and outward traversing processes. Then, an exchange would have taken place at the store 400, with the transfer device again having brought the diaphragm into the objective where it would have transferred it to the transfer or holding device, before traversing out of the objective again thereafter. Thus additional inward and outward traversing movements would have resulted, which are now eliminated. Since each movement of a component in the objective space can entrain contamination by particles and the like, the eliminated movements can have a great effect in terms of purity. Moreover, the additional component of the transfer or holding device in the objective can be dispensed with, a fact which reduces the effort on one hand and also can contribute to a reduction of contamination on the other.

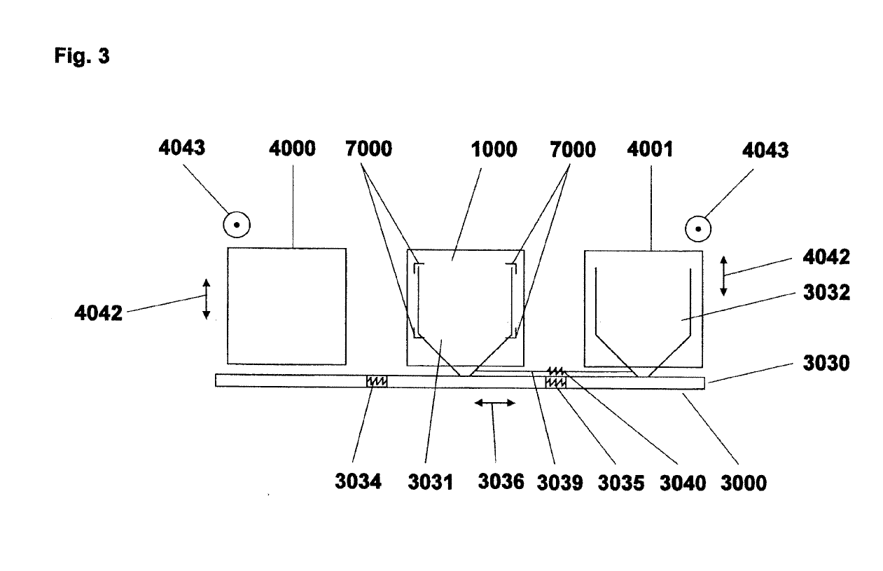

An objective is shown in FIG. 3. FIG. 3 shows an objective space 1000 and two stores 4000 and 4001 arranged as mirror-images to the objective space 1000.

Assigned to these is a transfer device 3000 with a rail arrangement 3030 along which a double receptacle with receptacles 3031 and 3032 can move. The double receptacles 3031, 3032 are connected by a coupling element 3039, such that synchronous movement of the 3031 and 3032 receptacles occurs. In coupling element 3039 is provided a damping element 3040, which effects decoupling from vibrations. Accordingly, the receptacle 3032 in the area of the store 4001 can, by a corresponding movement of the store 4001 along the arrow arrangements 4042 and 4043, be loaded or unloaded with a diaphragm, while simultaneously the receptacle 3031 is provided with a correspondingly arranged diaphragm in the objective space 1000.

Once the diaphragm in the objective space 1000 has to be changed, the arrangement of the two receptacles 3031 and 3032 with the coupling piece 3039 is moved along the rail arrangement 3030 in accordance with the double-headed arrow 3036, such that, for example, the receptacle 3031 in the area of the store 4000 and the receptacle 3032 is moved in the area of the objective space 1000. The diaphragm of the receptacle 3031 can then be removed from the area of the store 4000 or exchanged for a new one, while the diaphragm of the receptacle 3032 in the objective space 1000 is available for imaging with the objective.

In objective space 1000 in turn are provided stops 7000, which facilitate exact positioning of the diaphragm and/or the corresponding receptacles 3031 or 3032.

Via the damping element 3040 in the coupling piece 3039 and the damping elements 3034 and 3035, which are provided in the rail arrangement 3030, one of the receptacles 3031 or 3032 in the area of the stores 4000 or 4001 can be loaded and unloaded, without the vibrations or shocks generated thereby being transmitted to the corresponding other receptacle in the objective space 1000. This prevents the imaging properties of the objective from being impaired.

Additionally or alternatively, loading and unloading of the receptacle arranged outside the objective space 1000 can always occur at those times at which the shocks or vibrations are noncritical, for example when the immobilization of the diaphragm in the objective space 1000 is released.

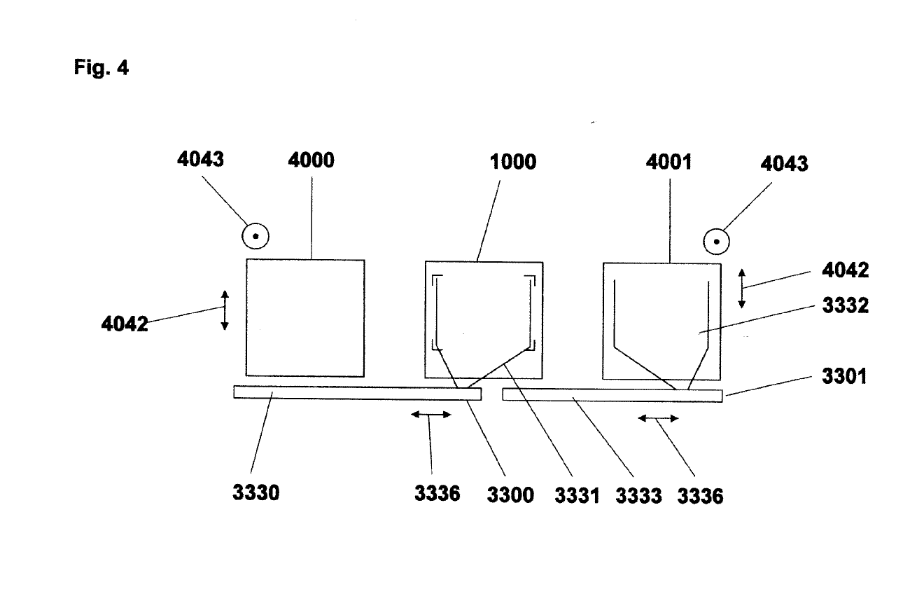

FIG. 4 is similar to FIG. 3, with, in turn, two stores 4000 and 4001 provided in mirror- image fashion next to the objective space 1000. Only the transfer device 3000 has been replaced by two transfer devices 3300 and 3301, each with a receptacle 3331 and 3332, which can move along the double-headed arrows 3336. Through the separate arrangement of two transfer devices 3300 and 3301, the damping elements can be dispensed with, since, due to the separation, transmission of shocks or vibrations can be largely avoided. In addition, the receptacles 3331 and 3332 can be moved independently of each other, such that non-synchronous movements of the two receptacles are possible as well. This is admittedly also achievable with FIG. 3, insofar as coupling of the receptacles is dispensed with.

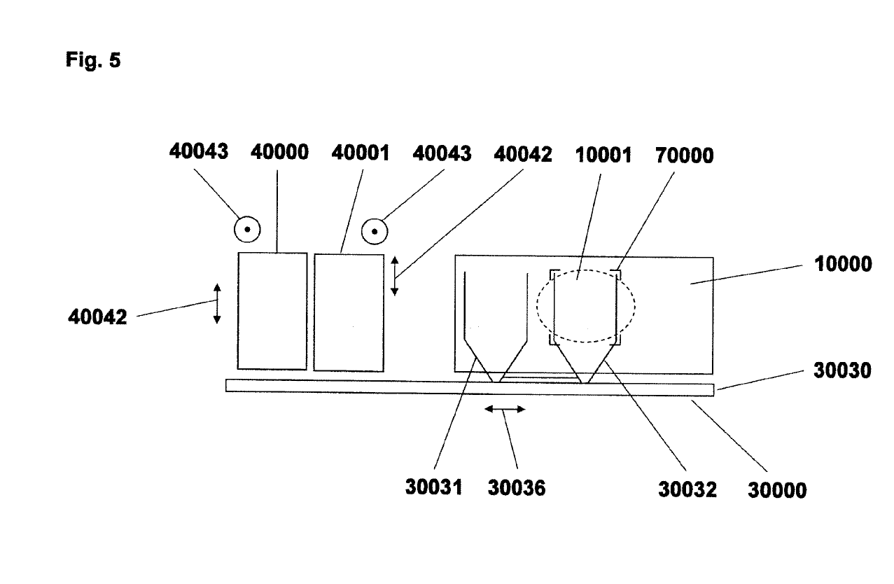

FIG. 5 shows an objective, in which, in turn, is provided a transfer device 30000 with two receptacles 30031 and 30032, which are coupled to each other and can move along a rail arrangement 30030 in accordance with the double-headed arrow 30036. However, in this exemplary embodiment, the two stores are not arranged on both sides of the objective space 10000, but rather are side by side on one side of the objective space. Accordingly, the objective space 10000 is larger, such that both receptacles 30031 and 30032 can be arranged in the objective space 10000. However, only one of the two receptacles, the receptacle 30032 in the embodiment shown, is arranged in the beam path 10001.

In this exemplary embodiment, it is not necessary initially for the objective space 10000 to be left in the event of a diaphragm change, since pushing the two coupled receptacles 30031 and 30032 enables the second receptacle to be moved into the beam path 10001. Insofar as two diaphragms are used very frequently, this leads to a significant potential for saving on movements or inward and outward traversing processes because the receptacles 30031 and 30032 can be moved inside the objective space 10000.

Only in the event that a third or further diaphragm is to be used are the coupled receptacles 30031 and 30032 moved out of the objective space 10000, with it possible for them to be simultaneously loaded with new diaphragms in the area of the stores 40000 and 40001. To this end, too, the stores 40000 and 40001 can be moved in accordance with the arrow arrangements 40042 and 40043. As a result, the loading time is correspondingly reduced due to the simultaneous loading of two receptacles 30031 or 30032.

FIG. 7 shows a projection exposure system, which can be operated with electromagnetic radiation from the extreme-ultraviolet range (EUV).

The projection exposure system 200 of FIG. 7 has a light source 201, whose light is directed by an illumination system 202 onto a reticle 203 where it impinges in a homogeneous distribution under defined angles.

The reticle 203 has a structure that is to be imaged onto a substrate 204. To this end, the reticle 203 is arranged in the object plane of a projection objective 205, by which imaging of the reticle 203 onto the surface of the substrate 204 occurs.

The projection exposure system of FIG. 7 is described in detail in DE 103 43333 A1, which is hereby incorporated by reference in its entirety.

The disclosure can now be implemented both in the projection objective 205 and in the illumination system 202 and especially in the pupil intermediate plane 207 of the sub-objective 206.

FIGS. 8 to 11 show examples of movement mechanisms or drives of the kind which can be realized in transfer devices for diaphragm changing.

FIGS. 8a and 8b are plan views of the cross-section of a housing 1 of a projection objective in which a diaphragm 2 is exchangeably accommodated. In 8a and 8b is shown a parallelogram guide 50 as part of a transfer device with receptacle 51, with the receptacle 51 and the diaphragm 2 arranged outside the housing 1 of the projection objective (8a) and with the parallelogram guide 50 moving the receptacle 51 into the housing 1 of the projection objective. FIGS. 8a and 8b each show a section of a vacuum wall 60, which is provided in addition to the housing 1 of the projection objective around the projection exposure system or parts thereof in which the projection objective 1 is accommodated. A sealable opening 61 is provided to facilitate through-passage of the diaphragm through the vacuum chamber wall 60.

As is especially evident from FIG. 8b, the parallelogram guide 50 has a total of four parallelogram rods, which are inter-connected in an articulated manner such that they can execute a shearing movement, such that the holding rod 52, at which is provided the receptacle 51 for the diaphragm 2, can execute a linear movement.

FIG. 9 is a side view of a further way of realising an actuation mechanism for the transfer device. In accordance with FIG. 9, a telescopic guide 150 is provided, at one end of which is provided the receptacle 151 for accommodating the diaphragm 2. The telescopic guide shown includes three telescopic arms 152 to 154, which can be mounted by a mounting plate 155 to the end opposite the receptacle 151. By collapsing the telescopic arms 152 to 154 and extending the telescopic arms 152 to 154, it is also possible for the receptacle 151 with diaphragm 2 to execute a linear movement for traversing into and out of the housing 1 of the projection objective. Here, too, an additional vacuum chamber wall 60 with corresponding closable and sealable opening for the transfer device 150 is provided.

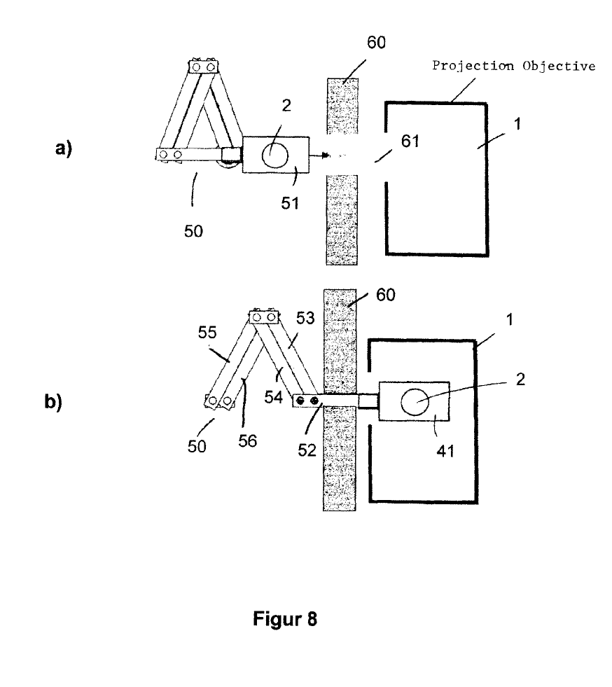

The same applies to FIGS. 10a and 10b. There, part of the transfer device is realised as a roller guide 250, which has a roller holder 253, which can be mounted permanently in the vacuum chamber wall 60. A guide rod 252, at the one end of which the receptacle 251 for the diaphragm 2 is provided, can be pushed through a corresponding opening in the vacuum chamber wall, with the guide rod 252 being guided and held by the roller holder 253. As is especially evident from FIG. 10a showing a cross-sectional view of the roller holder and the guide rod 252, several rolls or rollers can be provided between the roller holder 253 and the guide rod 252 for the purpose of facilitating low-friction, precision linear movement of the guide rod 252, as indicated by the dashes.

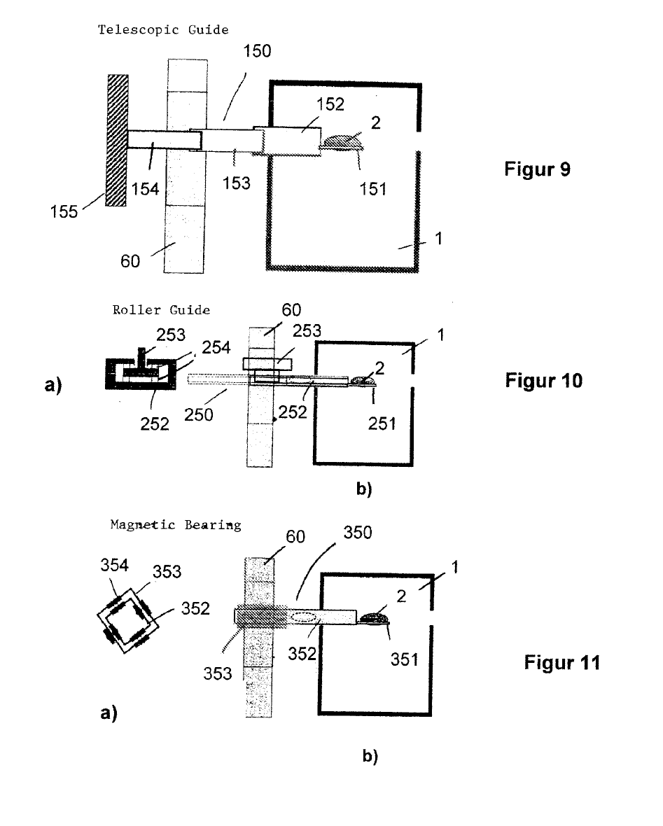

A movement or actuation mechanism for the transfer devices is shown in FIGS. 11a and 11b. Here, a magnetic bearing or a linear motor has been realised with which the guide rod 352 is accommodated so as to be capable of linear displacement in a magnetic holder 353, which in turn can be arranged in the vacuum chamber wall 60. Provided at the guide rod 352 in turn is the receptacle 351 for the diaphragm 2 for the purpose of moving this into the housing 1 and from the housing 1 of the projection objective, as shown in the side view of FIG. 11b.

FIG. 11a is a cross-sectional view of the magnetic bearing or the linear motor 350 with the magnetic holder 353 in which the guide 352 is accommodated. A homopolar arrangement of magnets at the magnetic holder 353 and at guide rod 352 makes it possible to maintain these at a distance from each other without physical contact, such that in turn a linear movement is possible. Corresponding actuation of the magnets, implemented as electromagnets, can additionally provide a driving force in the longitudinal direction for the guide rod 352. The magnetic bearing or the drive with linear motor affords the possibility, through corresponding control of the magnets as actuators, to effect a corresponding adjustment of the mounting position of the diaphragm 2.

Although the disclosure has been described in detail using the enclosed drawings, it is clear to a person skilled in the art that modifications or amendments through exclusion or other type of combination of the described individual characteristics are possible, without surrendering the scope of protection of the enclosed claims.

What is claimed is:

1. An imaging device, comprising:
a housing;
a diaphragm accommodated exchangeably in the housing; and
a first transfer device with a first receptacle,
wherein the diaphragm can be detachably arranged on or at the first transfer device so that that the diaphragm may be moved into or out of the housing, the first transfer device has an eigenfrequency equal to or greater than 100 Hz, and the imaging device is an optical system for microlithography.

2. The imaging device in accordance with claim 1, wherein the first transfer device is configured so that a diaphragm-changing time is less than or equal to 15 seconds.

3. The imaging device in accordance with claim 1, wherein the first transfer device has second receptacle.

4. The imaging device in accordance with claim 3, wherein the first receptacle may be arranged outside the housing, and the second receptacle may be arranged inside the housing.

5. The imaging device in accordance with claim 3, wherein the first and second receptacles may be arranged in the housing.

6. The imaging device in accordance with claim 1, wherein the first transfer device and the first receptacle can be moved by linear movement, rotary movement and/or swivelling movement.

7. The imaging device in accordance with claim 1, wherein the first transfer device and the first receptacle are movable in a first plane and a second plane that is perpendicular to the first plane.

8. The imaging device in accordance with claim 1, wherein the first receptacle is permanently accommodated in the first transfer device.

9. The imaging device in accordance with claim 1, wherein the first transfer device includes an actuation element mountable to the housing, and the first receptacle is detachably accommodated in the first transfer device.

10. The imaging device in accordance with claim 1, wherein the first transfer device comprises a parallelogram guide, a telescopic guide, a rail guide, a roller guide and/or a magnetic holder.

11. The imaging device in accordance with claim 1, further comprising at least one stop element in the housing to interact with the first receptacle and/or the first transfer device.

12. The imaging device in accordance with claim 1, wherein the diaphragm has a desired position, and the diaphragm can be arranged at a position that deviates less than or equal to 1 mm from the desired position.

13. The imaging device in accordance with claim 1, wherein the first transfer device comprises a sensor, an actuator and a control device, and wherein deviations from a set position and/or movements of the diaphragm are registered and compensated by a corrective actuation of the actuator.

14. The imaging device in accordance with claim 1, further comprising a second transfer device, wherein the first and second transfer devices are arranged in mirror-image fashion to the housing.

15. The imaging device in accordance with claim 1, further comprising a store to provision a plurality of diaphragms.

16. The imaging device in accordance with claim 15, wherein the first receptacle can receive the plurality of diaphragms directly from the store, and/or the first receptacle can deposit the plurality of diaphragms directly in the store.

17. The imaging device in accordance with claim 1, further comprising two stores arranged in mirror-image-like fashion to the housing.

18. The imaging device in accordance with claim 1, further comprising a store that is movable in at least one direction.

19. The imaging device in accordance with claim 15, further comprising a store, wherein the first transfer device can transfer diaphragms from the store to the first receptacle and vice versa.

20. The imaging device in accordance with claim 1, further comprising a closure element at the housing and/or a lock device at the housing.

21. The imaging device in accordance with claim 1, further comprising a store, wherein the first transfer device and/or the store are arranged in a vacuum chamber.

22. The imaging device in accordance with claim 1, further comprising a drive for the first transfer device, wherein the drive is arranged outside the housing.

23. The imaging device in accordance with claim 1, wherein the imaging device is an illumination system, a projection objective, a part of an illumination system, or a part of a projection objective.

24. The imaging device in accordance with claim 1, wherein the imaging system is an EUV projection exposure system for microlithography.

25. A system, comprising:
an illumination system; and
a projection objective,
wherein the illumination system or the projection objective comprises a diaphragm-changing device, a diaphragm-changing time is less than or equal to 15 seconds, and the system is a projection exposure system for microlithography.

26. A method, comprising:
a) providing an imaging device according to claim 1;
b) detachably attaching a diaphragm on or at the receptacle of the transfer device;
c) using the transfer device to move the diaphragm into the housing of the imaging device; and
d) immobilizing the diaphragm in the housing with the receptacle.

27. The method in accordance with claim 26, wherein, after d):
e) releasing the diaphragm;
f) removing the housing by the transfer device; and
g) removing the diaphragm;
h) using the diaphragm in the imaging system.

28. The method in accordance with claim 27, wherein, after h), steps b) through g) are performed again.

29. The method in accordance with claim 27, wherein concurrently with e) concerning a first receptacle, c) is performed concerning a second receptacle.

30. The method in accordance with any of claim 27, wherein concurrently with d) and e) concerning a first receptacle of the transfer device, b) and g) concerning a second receptacle of the transfer device are performed.

31. A method, comprising:
providing a projection exposure system for microlithography comprising an illumination system and a projection objective, an optical system selected from the group consisting of the illumination system and the projection objective comprises a diaphragm-changing device; and
removing a diaphragm from the optical system and introducing of a new diaphragm into the optical system occurs in a time less than or equal to 15 seconds.
